(19) United States
(12) Patent Application Publication
(10) Pub. No.: US 2007/0237022 A1
(43) Pub. Date: Oct. 11, 2007

(54) EXTRUDER MID-BARREL ADJUSTABLE VALVE ASSEMBLY

(76) Inventors: Philip B. Wiltz, Sabetha, KS (US); Galen J. Rokey, Sabetha, KS (US)

Correspondence Address: HOVEY WILLIAMS LLP, 2405 GRAND BLVD., SUITE 400, KANSAS CITY, MO, 64108, US

(21) Appl. No.: 11/279,379

(22) Filed: Apr. 11, 2006

(51) Int. Cl. B29C 47/74

(52) U.S. Cl. 366/80

(57) ABSTRACT

Flow restriction assemblies (10,10a) adapted to be mounted on single or twin screw extruders (17,102) in order to allow selective adjustment of material flow through the extruders (17,102), with consequent alteration in back pressure and shear conditions. The assemblies (10,10a) each have shearlock(s) (12,12a) mounted on the extruder drive shaft(s) (34,34a), together with restriction units (14,14a). The units (14,14a) have opposed flow restriction components (48,50,48a,50a) supported on opposite sides of the shearlock(s) (12,12a) and mounted for a substantially aligned and rectilinear back and forth sliding movement. In this fashion, the clearance between the inner surfaces (54,55,54a,55a) of the components (48,50,48a,50a) can be selectively adjusted. The assemblies (10,10a) are small in size and can be located at various points along the length of extruders (17,102)

### BACKGROUND OF THE INVENTION

1. Field of the Invention

The present invention is broadly concerned with extrusion devices equipped with mid-barrel flow restriction assembly permitting selective alteration back pressure and shear conditions, in order to optimize extrusion cooking. More particularly, the invention is concerned with such extruders, and the flow restriction assemblies, wherein the later have a pair of opposed, slidable restriction components and drive apparatus for selective movement of the components toward and away from the extruder screw(s) so as to achieve selective flow restriction.

2. Description of the Prior Art

Extrusion cooking devices are used in a multitude of contexts, e.g., for the fabrication of animal feeds and human food products. Generally speaking, single screw extruders include an elongated barrel having an inlet at one end and an outlet at the other equipped with a restricted orifice die. An elongated, flighted, axially rotatable screw is positioned within the barrel and serves to move material from the inlet toward and through the outlet. Twin screw extruders are also widely used, and include within the extruder barrel a pair of side-by-side, flighted, intermeshed screws. All such extruder devices serve to cook and form initial starting materials into final extruded products. During the course of extrusion, the starting materials are subjected to increasing levels of pressure and shear, in order to produce the desired, fully cooked, final extruded products.

It is often important during the operation of extruders to ensure that appropriate levels of pressure and shear are maintained within the extruder barrels. If too little pressure or shear is exerted upon the materials being processed, the final products may be undercooked, unsanitary, and badly formed. Various approaches have been used in the past to achieve and maintain appropriate levels of pressure and shear within extruder barrels. For example, it has been known to install one or more shearlock devices along the length of extruder screws. These shearlock devices are generally in the form of annular bodies which serve to create flow restrictions or choke points within the extruder, thereby increasing back pressure and shear. However, these devices are not adjustable during the course of extrusion runs, and considerable skill is required in the selection and placement of these shearlocks to achieve the desired end.

Variable restriction devices have also been proposed in the past, in order to permit on the go variation in flow restriction. For example, U.S. Pat. No. 4,136,968 describes a flow restriction device specifically adapted for use with twin screw extruders. In this device, use is made of opposed rotating paddle elements designed to interact with the meshed extruder screws in order to provide restricted material flow paths.

However, the apparatus as described in the '968 patent has a number of deficiencies. First and foremost, the design of the restriction device means that it cannot be use with single screw extruders, which is a significant drawback because it prevents application of the device on the broad spectrum of extruders presently in use. Moreover, the degree of flow restriction can be obtained with this prior design is limited, i.e., it is incapable of creating the very severe restrictions sometimes needed. By the same token, the paddles used in this device cannot be positioned so as to permit entirely unimpeded flow there past. Hence, the design is deficient at both extremes of potential use, where no added restriction is needed and where very high restriction levels are desired. Use of rotating paddles also means that the overall width of the device is significant, and this in turn can create “dead spots” in the device and make clean out more difficult.

There is a accordingly a need in the art for an improved extruder flow restriction device which can be used with both single and twin extruders, while allowing wide variation in flow restriction levels, and being of short length so as to eliminate dead spots while facilitating cleanout.

### SUMMARY OF THE INVENTION

The present invention overcomes the problems outlined above, and provides a flow restriction assembly adapted for use with an extruder having an elongated barrel and an axially rotatable screw therein. The flow restriction assembly comprises a pair of restriction components each presenting an inner surface, with structure supporting the restriction components in generally aligned relationship on opposed sides of a rotatable extruder screw. Apparatus is also provided for selectively moving the restriction components along substantially rectilinear and aligned paths toward and away from the screw, in order to vary the clearance between the screw and the inner surfaces of the components.

Preferably, the overall assemble includes a shearlock element mounted on the screw, and rotatable therewith, with the shearlock element presenting an outer surface generally complemental with the inner surfaces of the restriction components. Specifically, the outer operating surface of the shearlock element is normally substantially circular, whereas the inner surfaces of the restriction components are of arcuate design and generally mate with the shearlock element operating surface. However, it is preferred that the shearlock element outer surface and the inner surfaces of the restriction components be cooperatively configured such that, when the restriction components are located in closest adjacency with the shearlock element, at least one flow through passageway remains open.

The restriction components are advantageously mounted within a slotted body permitting inward and outward movement of the components along the aligned paths. The drive apparatus is preferably in the form of a screw drive coupled with each component, and the drive apparatus may be operated manually via cranks, or digitally controlled motors may be used.

### BRIEF DESCRIPTION OF THE DRAWING FIGURES

FIG. 1 is a perspective view of a flow restriction assembly in accordance with the invention;

FIG. 2 is a vertical sectional view of the flow restriction assembly in a representative open position, illustrating the internal structure thereof and also depicting alternate drive apparatus;

FIG. 3 is a fragmentary, horizontal sectional view depicting the flow restriction assembly of the invention between a pair of extruder barrel sections and associated screw sections;

FIG. 4 is a vertical sectional view similar to that of FIG. 2, but showing the assembly in its fully closed position;

FIG. 5 is a side view of the assembly, with the adjacent cover plate removed;

FIG. 6 is a fragmentary, perspective, exploded view depicting the connection between the drive assembly and restriction components; and

FIG. 7 is a vertical sectional view of another embodiment of the invention, designed for use with a twin screw extruder.

### DETAILED DESCRIPTION OF THE PREFERRED EMBODIMENT

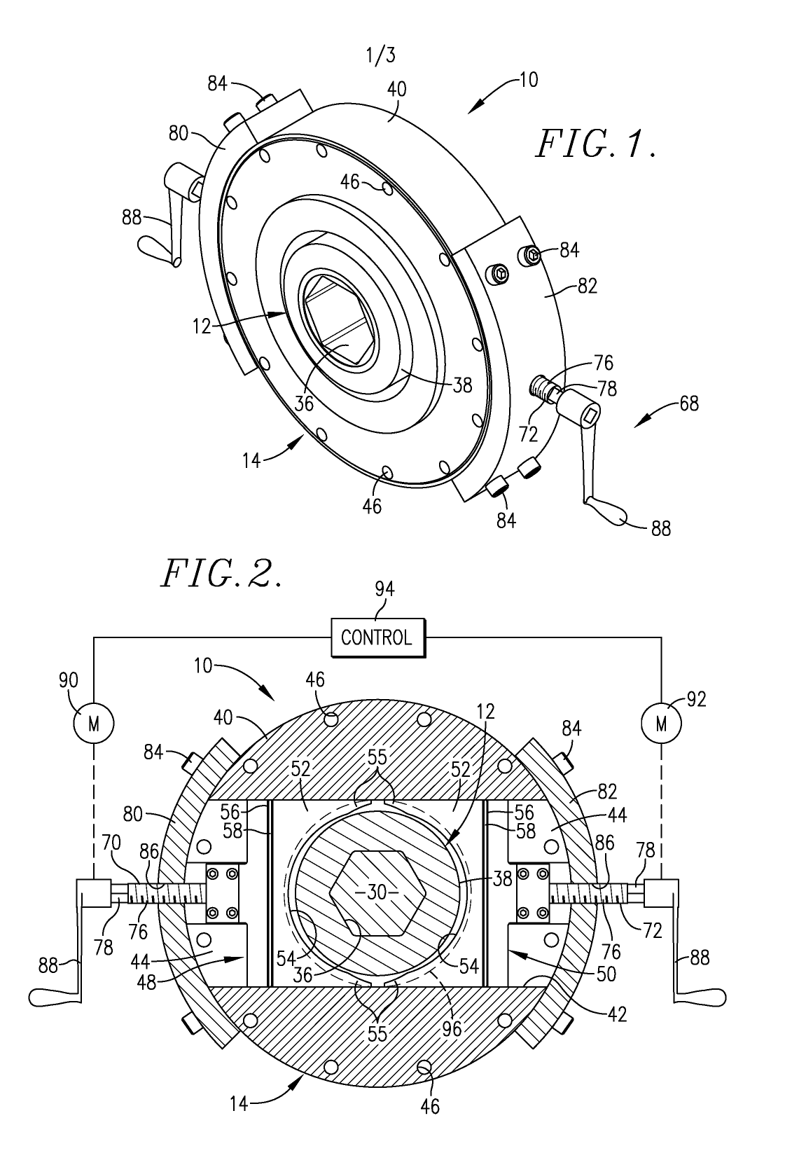

Turning now to the drawings, a restriction assembly 10 is illustrated in FIG. 1 and broadly includes a central shearlock element 12 and a mating, outboard restriction unit 14. The assembly 10 is designed for use with a single or twin screw extruder such as depicted in FIGS. 3 and 7, and is used to provide varying levels of flow restriction through the extruder barrel, in order to generate increased levels of back pressure and shear within the extruder.

By way of general background, the assembly 10 is designed for use in a conventional single or twin screw extruder 16 illustrated in FIG. 3. In a single screw extruder 17, an elongated barrel 18 is provided, made up of a series of elongated, tubular, axially aligned and interconnected head section 20. Each of these sections 20 have a pair of end most, radially, enlarged flanges 22 that are designed to be interconnected to form a barrel 18. In the form shown, each of the head sections 20 is equipped with an inner, helically flighted liner or sleeve 24 (in some embodiments, straight ribbed sleeves could be used in lieu of the helical sleeves). In addition, the extruder 16 includes an elongated, helically flighted screw 26 made up of screw section 28 each located within an associated head section 20. The screw sections 28 are mounted on a central, axially extending, hexagonal drive shaft 30 operatively coupled with the extruder drive (not shown). Alternately, a splined or keyed shaft may be employed. A twin screw extruder 32 (FIG. 7) is similar, with the barrel sections thereof designed to accommodate a pair of side-by-side, flighted, intermeshed screws now is on respective hexagonal or keyed drive shafts 34a.

Again referring to FIG. 3, it will be observed that the restriction assembly 10 of the invention is designed to be installed between a pair of head sections 20, and also between the associated screw sections 28 therein. Alternately, an assembly 10 could be built into an extruder barrel as a permanent feature, if desired.

In detail, the shearlock element 12 of assembly 10 is a solid annular metallic body having a central hexagonal bore 36 designed to receive the shaft 30, with a circular cross section presenting an outermost smooth operating surface 38. As such, the element 12 rotates in unison with shaft 30 and screw 26.

The restriction unit 14 includes a generally circular primary body 40 having a laterally extending through-slot 42 (FIG. 5) presenting a pair of side marginal openings 44. The body 40 is of metallic construction and has a series of axial bores 46 designed to mate with similar bores provided in the flanges 22 of head sections 20. Threaded fasteners (not shown) are used to interconnect the body 40 between a pair of adjacent flanges 22, so that the body 40 is in effect sandwiched between the aligned head sections 20.

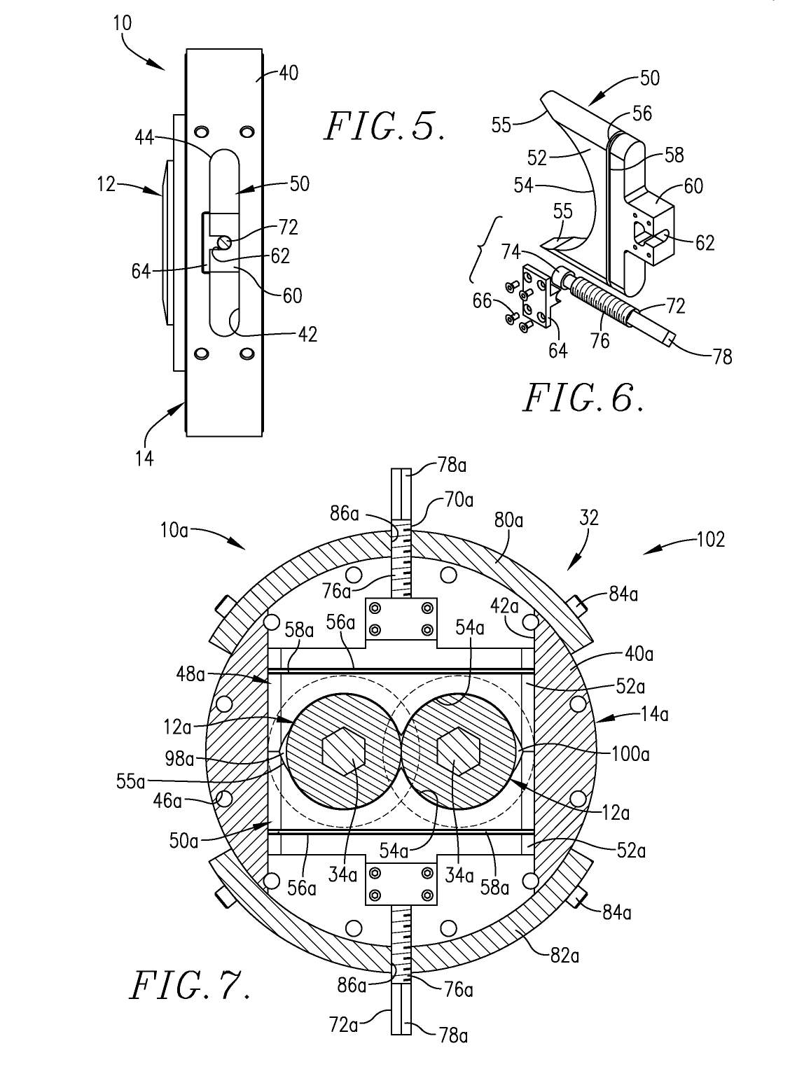

The unit 14 also includes a pair of closed restriction components 48,50 which are each slidably received within the slot 42. The components 48,50 are mirror images of each other and the construction thereof is best illustrated in FIG. 6. Thus, it will seen that each component has a metallic jaw-like body 52 presenting an innermost arcuate surface 54. The central region of each surface 54 is of essentially circular radius close to the radius of element 12, whereas the outboard region of each surface 54 has a pair of endmost, out of round projections 55 which are important for purposes to be explained. Each body 52 is equipped with a circumscribing groove 56 which receives a flexible seal 58. Each body 52 also has an integral, outwardly extending ear 60 having an end notch 62 formed therein. A plate 64 is disposed over the notch 62 and is secured in place by fasteners 66.

Unit 14 further includes a drive apparatus 68 operatively coupled with the components 48, 50 in order to move these components toward or away from the sherlock element 12 that will be explained. The drive apparatus 68 includes a pair of drive screws 70,72 having forward butt ends 74, central threaded sections 76, and square drive ends 78. Again referring to FIG. 6, it will be seen that the forward butt end 74 of each drive screw 70,72 is located within the notch 62 of the associated body 52, with the remainder of the screw extending outwardly.

The drive apparatus 68 further includes a pair of arcuate cover plates 80,82 respectively exposed over a side opening 44, and secured in place by fasteners 84. Each of the plates 80,82 has a central, threaded bore 86 receiving threaded section 76 of an associated drive screw 70,72. It will thus be appreciated that rotation of the drive screws 70,72 serves to slide the component 48,50 inwardly or outwardly so as to define a selected clearance between the surfaces 54,55 of the components 48,50 and the operating surface 38 of shearlock element 12. Such rotational movement of the drive screw 70,72 can be effected manually through the use of cranks 88 affixed to the drive ends 78. Alternately, and as schematically depicted in FIG. 2, respective motors 90,92 can be coupled to the drive screws 70,72 for motorized movement of the restriction components 48,50. Typically, the motors 90,92 would be coupled to a controller 94 which may form a part of the overall digital control for the extruder.

In use, the assembly 10 is installed by first sliding the shearlock element 12 onto shaft 30 at a selected location, usually at the end of a head section 20. Thereupon, the restriction unit 14 is located in alignment with the flange 22 of the adjacent head section 20, and the next head section 20 with the associated screw section 28, is installed. Bolts or other fasteners (not shown) are then used to secure the unit 14 in place between the flanged ends of the head sections 20.

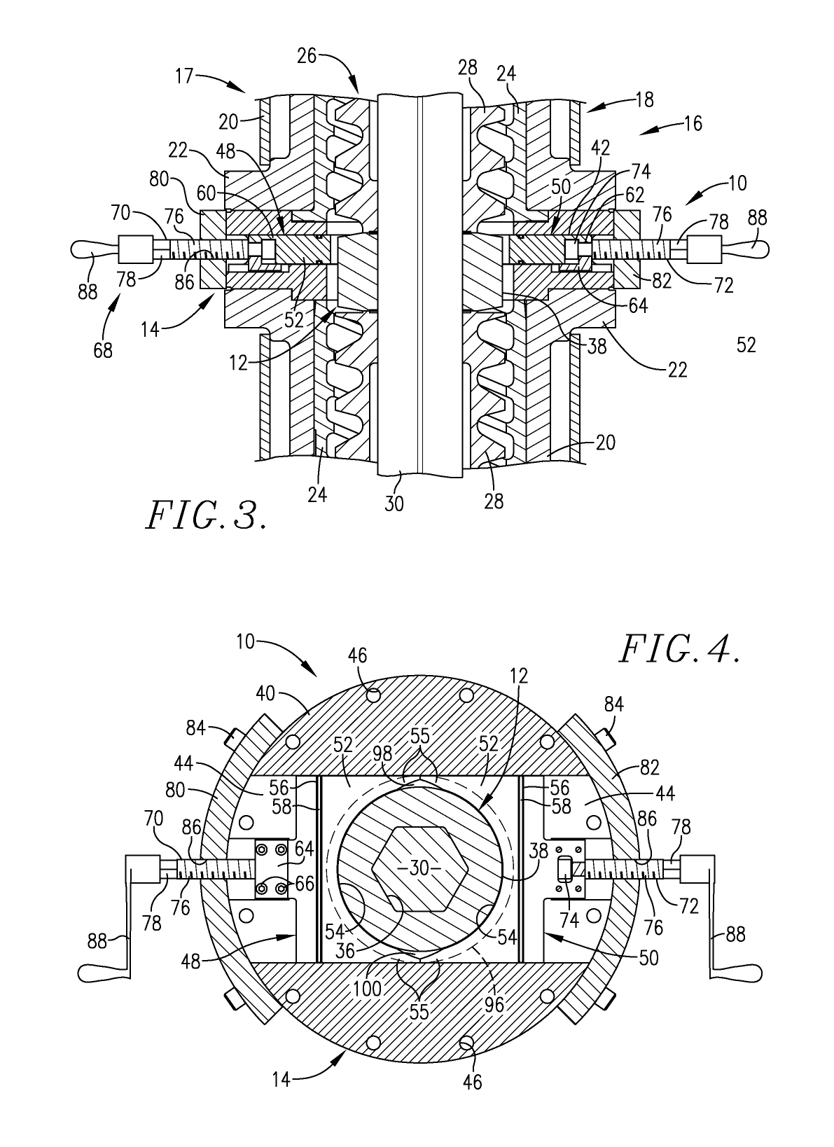

During use of the extruder, the restriction unit 14 can be adjusted to give varying clearances between the surfaces 54,55 of the restriction components 48,50, and the operating surface 38 of shearlock element 12. This is accomplished by appropriate rotation of cranks 88 (or in the automated version by energization of motors 90,92) continuing so as to slide the components 48,50 along essentially aligned and rectilinear paths defined by slot 42 toward and away from element 12. Thus, a representative open position of the unit 14 is depicted in FIG. 2, where it will be observed that the surfaces 54 are closely adjacent to the innermost surface 96 of the barrel 18 defined by the respective sleeves 24. The “full-closed” position of the unit 14 is shown in FIG. 4 where a majority of each surface 54 is in close engaging relationship with the surface 38. However, it will be seen that the projecting surface regions 55 do not fully mate with or engage the shearlock element surface 38 so as to define, even in the “full-closed” position, small upper and lower passageways 98,100. This is to ensure that the assembly 10 will not completely block lower material through the extruder, even in the “full-closed” position thereof.

FIG. 7 illustrates a flow restriction assembly 10a for use in a twin screw extruder 102 having side-by-side intermeshed screws within an appropriately configured barrel. The components of assembly 10a are, for the most part, identical with those of assembly 10, and therefore like reference numerals have been used in FIG. 7, except for the distinguishing letter “a.” Thus, the assembly 10a has a pair of shearlock elements 12a, each respectively mounted on one of the extruder shafts 34a. Also, a pair of opposed, flightable restriction components 48a,50a are provided, preferably mounted in a vertical orientation, as shown. The inner operating surfaces 54a,55a of the components 48a,50a have a pair of juxtaposed arcuate regions so as to simultaneously accommodate and engage both of the shearlock elements 12a. Additionally, the surfaces 55a define flow passageways 98a,100a when the assembly 10a is in the full-closed position illustrated in FIG. 7. From the foregoing discussion, it will be readily appreciated that the components 48a,50a move along essentially aligned and rectilinear paths toward and away from the shearlock elements 12a, upon rotation of the drive screws 70a,72a.

A principal advantage of the flow restrictions assemblies of the invention stems from use of sliding flow restriction components 48, 50, 48a, 50a as opposed to the rotatable restrictors of the prior art, as exemplified in U.S. Pat. No. 4,136,968. Indeed, the units 14, 14a of the invention can be constructed with only a minimum width, preferably less than about three inches. Accordingly, there is little tendency to create “dead spots” within the assemblies 10, 10a, which contributes to the cleanliness and operational efficiency of the assemblies and the overall extruders. Moreover, the present assemblies 10, 10a are advantageously designed so that, in the “full-open” positions thereof, the components 48, 50, 48a, 50a provide essentially unimpeded flow of material through the extruder barrel.

It will also be appreciated that the assemblies 10, 10a of the invention may be mounted at a variety of different locations along the length of a single or twin screw extruder. This gives an operational flexibility not readily available with other designs. In addition, the size and shape of the shearlock elements and the associated flow restriction components can be varied to change minimum and maximum flow areas, as well as other material flow characteristics. Additionally, while only a single assembly is illustrated in the drawings, it will be appreciated that one or more of these assemblies may be used along the length of a given extruder. This may provide additional degrees of operational flexibility in certain extrusion contexts.

What is claimed is:

1. A flow restriction assembly adapted for use with an extruder having an elongated barrel and an axially rotatable screw therein, said assembly comprising:
a pair of restriction components each presenting an inner surface;
structure supporting said restriction components in generally aligned relationship on opposed sides of a rotatable extruder screw; and
apparatus for selectively moving said restriction components along substantially rectilinear and aligned paths toward and away from said screw, in order to vary the clearance between the screw and said inner surfaces of said components.

2. The flow restriction assembly of claim 1,
including a shearlock element mounted on said screw and rotatable therewith,
said shearlock element presenting an outer surface generally complemental with said inner surfaces of said restriction components.

3. The flow restriction assembly of claim 2,
said outer surface of said shearlock element being substantially circular, said inner surfaces of said restriction components being arcuate and generally mating with said circular sherlock element surface.

4. The flow restriction assembly of claim 2,
said shearlock element outer surface and said inner surfaces of said restriction components being cooperatively configured such that, when the restriction components are located in their closest adjacency with said shearlock element, at least one flow-through passageway is defined.

5. The flow restriction assembly of claim 1,
said supporting structure comprising a body having a transverse opening,
said components being slidedly received within said opening.

6. The flow restriction assembly of claim 5,
including a pair of cover plates disposed over the outer ends of said opening.

7. The flow restriction assembly of claim 1, s
aid apparatus comprising a screw drive operatively coupled with each of said components.

8. The flow restriction assembly of claim 7,
each of said screw drives having a manually operable crank for operation thereof.

9. The flow restriction assembly of claim 7,
said apparatus including a pair of drive motors respectively operatively coupled with each of said screw drives, there being a controller coupled with each of said motors.

10. The flow restriction assembly of claim 1,
the thickness of said supporting structure being less than about three inches.

11. The flow restriction assembly of claim 1,
said components and inner surfaces configured to mate with a shearlock element mounted on a single extruder screw.

12. The flow restriction assembly of claim 1,
said component inner surfaces configured to mate with respective shearlock elements each mounted on one of two intermeshing screws of a twin screw extruder.

13. An extruder comprising:
an elongated barrel;
an elongated axially rotatable screw within said barrel; and
at least one restriction assembly located along the length of said barrel and comprising
a pair of restriction components each presenting an inner surface;
structure supporting said restriction components in generally aligned relationship on opposed sides of said rotatable extruder screw; and
apparatus for selectively moving said restriction components along substantially rectilinear and aligned paths toward and away from said screw, in order to vary the clearance between the screw and said inner surfaces of said components.

14. The extruder of claim 13,
including a shearlock element mounted on said screw and rotatable therewith,
said shearlock element presenting an outer surface generally complemental with said inner surfaces of said restriction components.

15. The extruder of claim 14,
said outer surface of said shearlock element being substantially circular, said inner surfaces of said restriction components being arcuate and generally mating with said circular sherlock element surface.

16. The extruder of claim 14,
said shearlock element outer surface and said inner surfaces of said restriction components being cooperatively configured such that, when the restriction components are located in their closest adjacency with said shearlock element, at least one flow-through passageway is defined.

17. The extruder of claim 13,
said supporting structure comprising a body having a transverse opening,
said components being slidedly received within said opening.

18. The extruder of claim 17,
including a pair of cover plates disposed over the outer ends of said opening.

19. The extruder of claim 13,
said apparatus comprising a screw drive operatively coupled with each of said components.

20. The extruder of claim 19,
each of said screw drives having a manually operable crank for operation thereof.

21. The extruder of claim 19,
said apparatus including a pair of drive motors respectively operatively coupled with each of said screw drives, there being a controller coupled with each of said motors.

22. The extruder of claim 13,
the thickness of said supporting structure being less than about three inches.

23. The extruder of claim 13,
there being a single extruder screw,
said components inner surfaces mating with a shearlock element mounted on said single screw.

24. The extruder of claim 13,
there being a pair of intermeshed extruder screws,
said component inner surfaces mating with respective shearlock elements each mounted on one of said intermeshed extruder screws.
